(19) United States
(12) Patent Application Publication
(10) Pub. No.: US 2012/0103969 A1
(43) Pub. Date: May 3, 2012

(54) CONTAINER WARMER APPARATUS

(76) Inventor: Igal Sharon, Caesaria (IL)

(21) Appl. No.: 13/382,294

(22) PCT Filed: Jul. 6, 2010
(86) PCT No.: PCT/IL10/00540

§ 371 Date: Jan. 5, 2012

(30) Foreign Application Priority Data
Jul. 6, 2009 (IL) 199711

(51) Int. Cl. A47J 36/26; H05B 1/02; B23P 11/00; H05B 3/02

(52) U.S. Cl. 219/432; 219/433; 219/434; 219/470; 219/480; 219/494; 29/428

(57) ABSTRACT

A warming apparatus for warming a container having outer walls, the apparatus including a warmer body, at least one container holder, open at both ends, defined in the body, the container holder including holder walls adapted and configured to cradle a portion of the outer walls of a container for releasably holding that portion of the outer walls, and at least one heating element disposed in the warmer body adjacent the container holder.

### FIELD OF THE INVENTION

The present invention relates to a container warming apparatus, in general and, in particular, to a warmer for a single or multi compartment container.

### BACKGROUND OF THE INVENTION

Container warmers are known in the art and include a variety of devices for warming containers. Typically, each warming device is adapted to warm a certain kind of container. One known container warming device is a baby bottle warmer, which is used for warming the formula, milk or other nutriments stored inside baby bottles or other containers for baby nutriments.

One example of such a baby bottle warmer is disclosed in U.S. Pat. No. 6,427,863 to Nichols, where a thermos base with an insulted cup is filled up with water which is heated to a predefined temperature. A baby bottle is placed inside the hot water and is retained therein until the food inside the bottle reaches the desired temperature. Nichols further describes a cap with a plurality of vent holes, which allows steam from the hot water in the insulated cup to escape. The bottle warmer according to this US patent permits the bottle to be disposed therein and heated in an upright position only and the heat generated by the warmer spreads upwards to all parts of the bottle heating the entire formulation which it contains.

Baby formulas typically require several steps for preparation. First, sterilized or purified liquid, such as water, must be measured into the bottle. Second, the powdered formula must be measured and added to the liquid, and third, the formulation may be warmed to a proper temperature before feeding the baby, particularly if it is prepared in advance and stored in a refrigerator. This is a time consuming process for a user, especially when the baby is hungry and crying. In addition, sterilized or purified water or other materials, such as substances in powdered form, are not available at all locations, or appropriate facilities for preparing them may not be available, when it is desired to prepare the formulation.

There are also known a wide variety of containers having two compartments for storing separately different components for combining to form a desired formulation immediately prior to consumption. One example of such a container is shown in U.S. Pat. No. 6,113,257 to the present applicant. This patent describes a container including a housing with a dispensing opening and a neck portion between the opening and a bottom end of the housing; and a displaceable member disposed within the housing and having a partition wall with an edge adapted for a sealing engagement with the internal walls of the neck portion, thereby defining two compartments separated by the partition wall. The displaceable member is axially displaceable between two positions along an axis extending through the neck portion, the two positions comprising a first position, where the edge of the partition wall sealingly engages the internal walls of the neck portion, and a second position, where the edge and the internal walls are disengaged permitting flow communication between the two compartments.

Typically, one compartment of the multi-compartment container is filled with one component in powdered form of the formulation, and a second compartment is filled with water or other liquid at a desired temperature and is mixed with the component contained in the first compartment just prior to use. In case of a baby bottle, the multi-compartment container is pre-filled with water in one compartment and powder in the second compartment. Prior to forming the formulation and feeding a crying baby, the water needs to be heated to a proper temperature. In order to speed up the start of the feeding, it would be an advantage if the water is kept warmed at a desirable temperature up until just prior to use while both components of the formulation are already stored in the container. However, heating up the multi-compartment container by known baby bottle warmers may result in heating both the water and the powdered component for extended periods of time. It is known that heating certain substances for extended periods of time may cause an undesirable structural change in the macromolecules of the substance, in a process known as denaturation. Thus, placing a pre-filled multi-compartment container in a conventional bottle warmer in the upright position may result in undesirably heating up all the components in the container, since heat naturally rises.

Accordingly, there is a long felt need for a container warmer that will heat substantially only one or more desired portions of a single compartment or a multi-compartment container.

### SUMMARY OF THE INVENTION

There is provided, according to the present invention a warming apparatus for warming at least one container having outer walls, which can be a single- or multi-compartment container. The apparatus includes a warmer body, at least one container holder, open at both ends, defined in the body, the container holder including holder walls adapted and configured to cradle a portion of the outer walls of a container for releasably holding that portion of the outer walls, and at least one heating element disposed in the warmer body adjacent the container holder.

According to one embodiment the container holder has a shape complementary to a portion of the container for releasably cradling that portion.

According to another embodiment the warmer body further includes a temperature selector associated with each container holder.

According to one embodiment of the invention, the warmer body further includes a portable energy source.

According to another embodiment of the invention, the warmer body further includes a car outlet plug.

There is also provided, according to the invention, a warming apparatus for warming a multi-compartment container, the apparatus including a warmer body, at least one container holder defined in the body, each for holding a multi-compartment container in a substantially horizontal position, each container holder being sized to hold a portion of the container, and at least one heating element disposed in the body, one of the heating elements being disposed adjacent one of the container holders for heating at least a portion of the container holder.

Still further according to the invention, there is provided a method for forming a warming apparatus for warming a container having outer walls, the method including forming warmer body, defining at least one container holder, open at both ends, in the warmer body for releasably holding a container, forming holder walls in the container holder sized and configured to cradle a portion of the outer walls of a container, and disposing at least one heating element in the warmer body adjacent the container holder.

### BRIEF DESCRIPTION OF THE DRAWINGS

The present invention will be further understood and appreciated from the following detailed description taken in conjunction with the drawings in which:

FIG. 1a is a side perspective schematic illustration of container warmer constructed and operative in accordance with one embodiment of the present invention;

FIG. 1b is a side perspective schematic illustration of container warmer constructed and operative in accordance with one embodiment of the present invention;

FIG. 2 is a side view illustration of the container warmer of FIG. 1b;

FIG. 3 is a top view illustration of the container warmer of FIG. 1b;

FIG. 4 is a side perspective view illustration of the container warmer of FIG. 1b holding a multi-compartment bottle;

FIG. 5 is a side view illustration of the container warmer of FIG. 1b holding a multi-compartment bottle;

FIG. 6 is a top view illustration of the container warmer of FIG. 1b holding a multi-compartment bottle;

FIG. 7 is a perspective view illustration of a container warmer constructed and operative in accordance with another embodiment of the present invention;

FIG. 8 is a perspective view illustration of a heating unit for a container warmer constructed and operative in accordance with one embodiment of the present invention;

FIG. 9 is a perspective view of a container warmer constructed and operative in accordance with another embodiment of the present invention; and

FIG. 10 is an end view of the container warmer of FIG. 9.

### DETAILED DESCRIPTION OF THE INVENTION

The present invention relates to a container warming apparatus for warming at least one container having outer walls. The container can be a single compartment or multi-compartment container, which may contain substances in one or more compartments while being warmed. The warming apparatus includes a warmer body defining at least one cradle or container holder, open at both ends, and having holder walls adapted and configured to cradle a portion of the outer walls of a container for releasably holding a portion of the container. A heating element is disposed in the warmer body adjacent the container holder for heating a portion of the container which is placed in the cradle.

According to the invention, only a desired portion of the container held in the container holder is heated by the container warmer, while other portions of the container are not warmed or are warmed very little. Thus, the container can be held in a horizontal position, meaning holding the container in a position wherein all of its compartments are substantially leveled in respect to each other and the horizon. The container can also be held in a substantially horizontal position, which includes an acute angle from the horizontal, i.e., about 45° or less, whereby only the desired portion of the container held in the container holder is heated by the container warmer. Alternatively, the container can be held substantially vertically, where the portion to be heated is held above the portion not to be heated, to prevent warming by convection. According to some embodiments of the invention, holder holds the container so that it cannot not fall out unintentionally. Thus, the container holder may be sized for snap fit, or may include conventional flexible stopper elements, as so forth, such that no external means are required to retain the container in the holder/cradle.

According to one embodiment, the cradle of the warming apparatus is sized to permit warming of a portion of a multi-compartment container, and preferably the outer walls of one compartment of the container, while the other portions of the container or other compartments extend outside the cradle. Holding the container in a substantially horizontal position on the warmer apparatus prevents the heat, which naturally rises from the heating element of the warmer and the heated portion of the container, from reaching other portions of the container and heating their contents, as well. This is of particular importance when one substance in a first compartment of the multi-compartment container is being heated, while a second substance contained in a second compartment can be denaturalized when exposed to heat. The warming apparatus according to the present invention allows, for example, heating water contained in one compartment of a two-compartment baby bottle without heating a powdered baby formula contained in the second compartment of the bottle before mixing the two components into a formulation and feeding a baby.

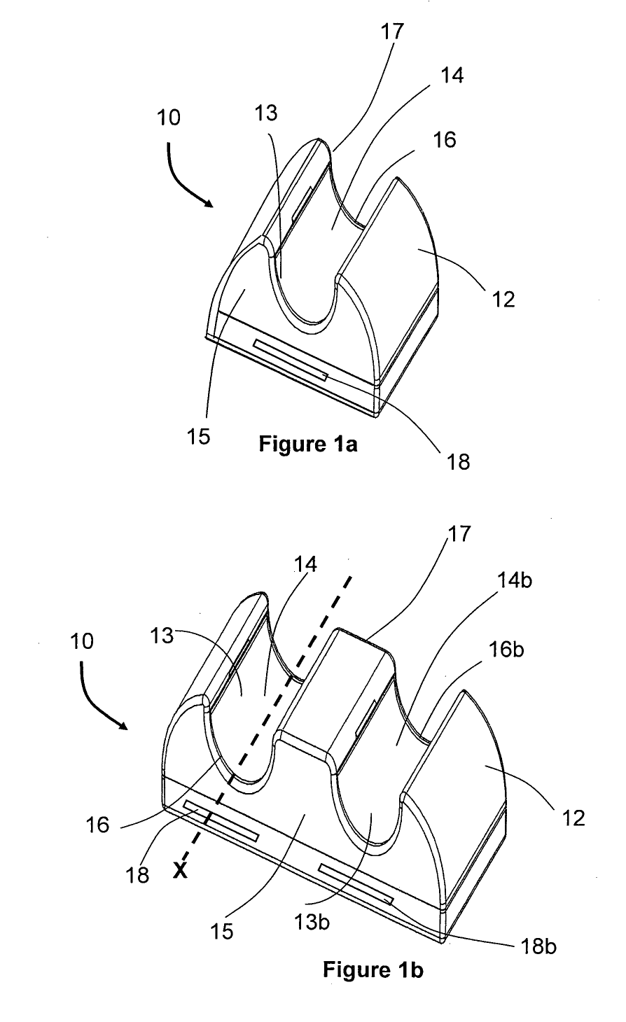

FIG. 1a is a perspective view of a container warmer constructed and operative in accordance with one embodiment of the present invention. Container warmer 10 includes a warmer body 12 having a heating element 18 which can be energized by any conventional power source. It is a particular feature of the present invention that warmer body 12 defines a container holder, here illustrated as a cradle 14, open at both ends, having holder walls 13 for releasably holding or engaging a single- or multi-compartment container in a horizontal position. Cradle 14 is defined in body 14 along a horizontal axis X through body 12. Preferably, cradle 14 is formed with a semi-cylinder shape, which is complementary to typical cylindrically shaped contours of the outer walls of the container, for engaging the outer walls of the container. Cradle 14 extends from one outside wall 15 of body 12 to a second outside wall 17 of body 12, and is open on both ends. Preferably, cradle 14 is sized along axis X to hold a portion of the container, while the other portion or portions of the container extend outside of either one or both ends of cradle 14 and, preferably, of body 12. The heating element heats at least a portion of the cradle which, in turn, heats the outer walls of the portion of the container held therein. The portions of the container which extend outside of cradle 14 are not in contact with warmer body 12, thus remain substantially unheated. Furthermore, these portions of the container are surrounded by ambient air, which enhances heat convection away from these portions.

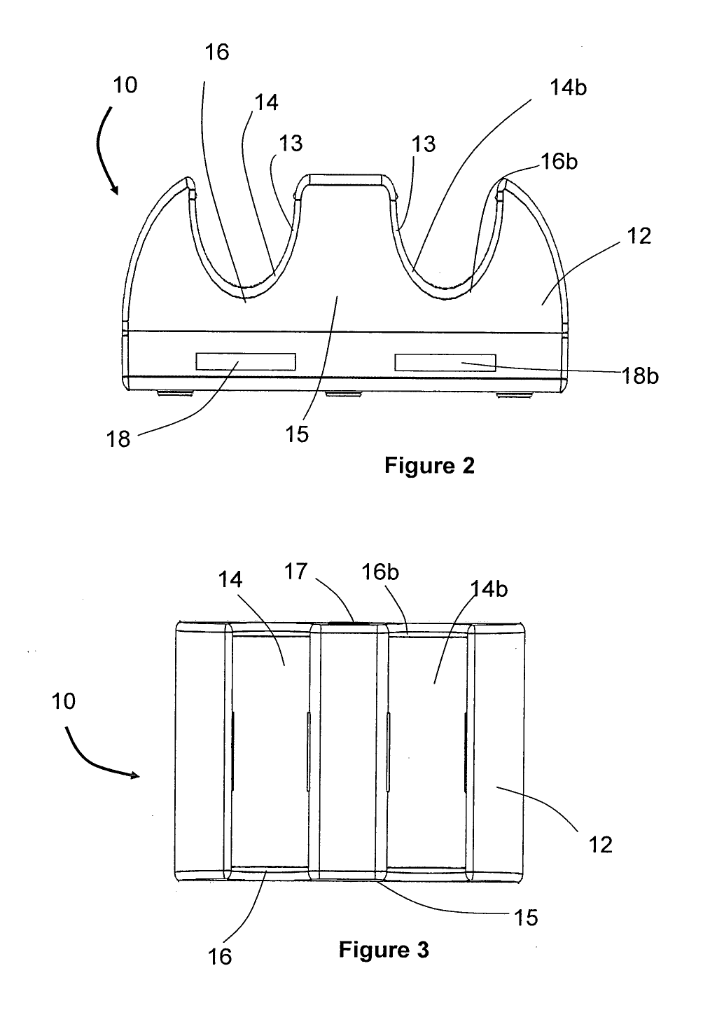

FIGS. 1b, 2 and 3 are perspective, side, and top views, respectively, of a container warmer constructed and operative in accordance with an alternative embodiment of the present invention including two container holders, here illustrated as cradles 14 and 14b, each for holding a container in a substantially horizontal position, substantially as described above with regard to FIG. 1a. Container warmer 10 includes a warmer body 12 having heating elements 18, 18b associated with each container holder, which can be energized by any conventional power source. The heating elements heat at least a portion of the cradles which, in turn, heat the portions of side walls of the containers held therein and preferably can be energized individually and independently. An on/off switch (not shown) is provided in the warmer body for selectively energizing heating elements 18, 18b. The portions of the container which extend outside of cradle 14 are not in contact with warmer body 12, thus remain substantially unheated. Furthermore, these portions of the container are surrounded by ambient air, which enhances heat convection away from these portions.

According to other embodiments of the present invention, cradle 14 may be formed in various shapes to complement the contours of the outer walls of containers having unconventional shapes, such as rectangular or hexagonal, etc. Preferably, the shape of cradle 14 complements the contours of the outer walls of that portion of the container which it is desired to heat.

Preferably, wall 13 of cradle 14 is lined with a heat-conductive plate 16, wherein one side of the plate is adapted to engage, or to be mounted in close proximity to, the heating element in body 12, and the second side of the plate lines cradle 14 and is mounted adjacent a portion of the container to be heated. According to another embodiment, the heating element in body 12 heats a heat convection medium, such as oil or other liquid or heat transferring material, wherein the medium is contained in body 12 and contacts cradle 14 for heating at least a portion of the cradle.

Heat-conductive plate 16 can be made of any heat conductive material, such as metal or other materials having similar heat conductive characteristics. Plate 16, according to this embodiment, is semi-cylindrically shaped and is arranged to completely line cradle 14, as shown in FIG. 1a. Alternatively, plate 16 may be arranged to line a portion or selected portions of cradle 14. For example, heat-conductive plate 16 may consist of several metal strips (not shown) disposed in cradle 14 between its open ends along axis X, or around its circumference perpendicular to axis X. According to yet another embodiment, plate 16 may consist of a heating element. Such plate 16 or preferably a plurality of such plates can be mounted in cradle 14 or in a portion or portions thereof (not shown).

Container warmer 10, as shown in FIG. 1b, includes a second container holder, here a second cradle 14b having holder wall 13b, which is lined with a heat conductive plate 16b. Second cradle 14b may be used simultaneously with cradle 14. Alternatively, cradles 14 and 14b may differ in diameter or shape, each adapted to hold a container having a different diameter or shape.

Preferably, container warmer 10 includes a thermostat (not shown) associated with each container holder, for maintaining the heating temperature in each holder at a prescribed level, for example, 38° C. in case the container warmer 10 is used for warming baby bottles. In addition, container warmer 10 may further include a temperature selector (not shown), associated with each container holder, which may be adjusted in accordance with the substance to be heated and the desired temperature. According to yet another embodiment, body 12 may include a heating element for each cradle 14 and 14b, wherein one heating element may be set to one pre-selected temperature, while the second heating element is set to another pre-selected temperature.

Container warmer 10 may further include a portable power source, such as batteries, and/or a car plug, for using a car battery as a power source.

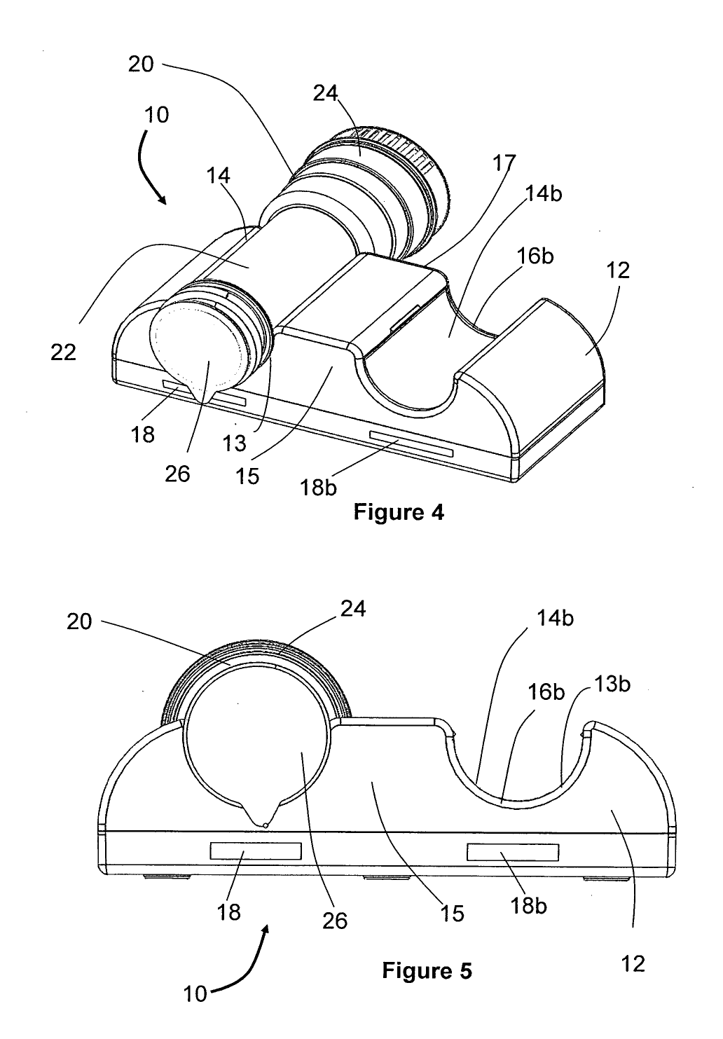

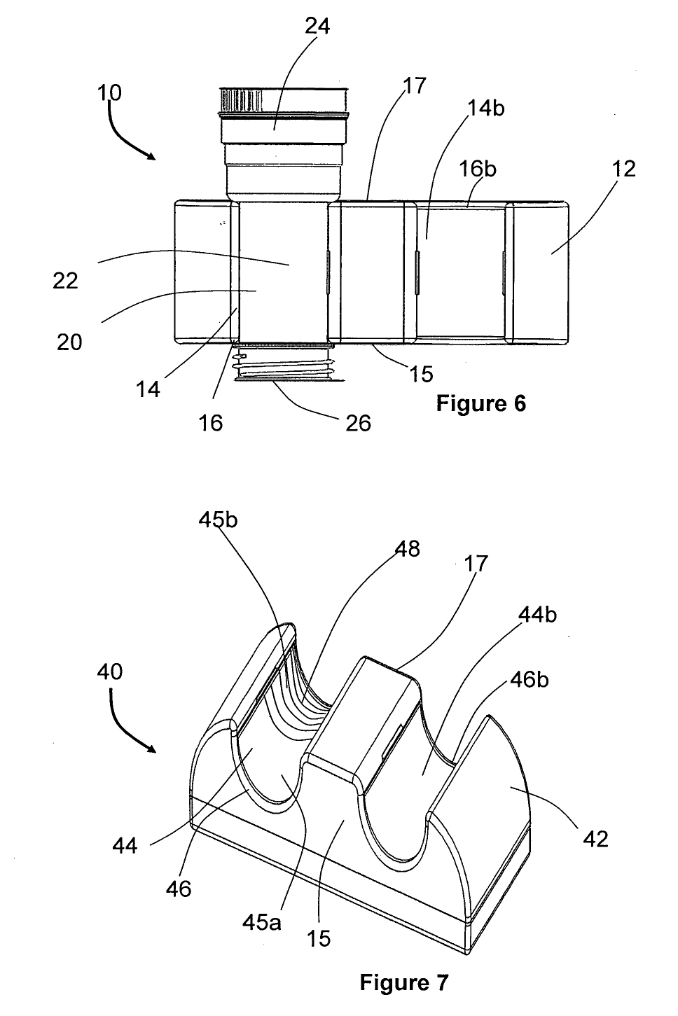

FIGS. 4, 5, and 6 are perspective, side, and top views, respectively, of container warmer 10 of FIG. 1 holding a multi-compartment bottle 20 thereon. Bottle 20 includes a first compartment 22, a second compartment 24, and bottle cap 26. Second compartment 24 includes a partition wall (not shown), which may be selectively opened, so as to permit flow communication between the two compartments. The components contained in the two compartments may form, for example, a formula for feeding a baby, or another food product or a medication, when mixed together.

It is a particular feature of the present invention that the warming apparatus permits continual warming of only one component before it is mixed with the second component, where the second component is undesirably sensitive to heat. If the user wishes to heat the component which is stored in compartment 22 while avoiding heating the component stored in compartment 24, multi-compartment bottle 20 is placed on bottle warmer 10, here illustrated in a horizontal position, by disposing first compartment 22 inside cradle 14 as shown, resulting in physical contact between the outer walls of compartment 22 and heat-conductive plate 16 in wall 13. The length of cradle 14 is arranged so as to engage the outer walls of compartment 22 only, while the outer walls of compartment 24 extend outside of cradle 14, thus avoiding direct contact with warmer body 12, so as to minimize heat convection from heat-conductive plate 16 to compartment 24. Placing bottle 20 on bottle warmer 10 in a horizontal position substantially eliminates heat convection from heated compartment 22 to compartment 24 (which may occur in conventional bottle warmers by heat naturally rising from first compartment 22 to compartment 24 when bottle 20 is vertically placed and heated). Once the temperature of the component in compartment 22 reaches the desired level, bottle 20 may be removed and the partition wall in the multi-compartment container can be opened, thus permitting flow communication between the two compartments and mixing of the heated component in compartment 22 with the non-heated component in compartment 24, to form a mixture ready for immediate consumption.

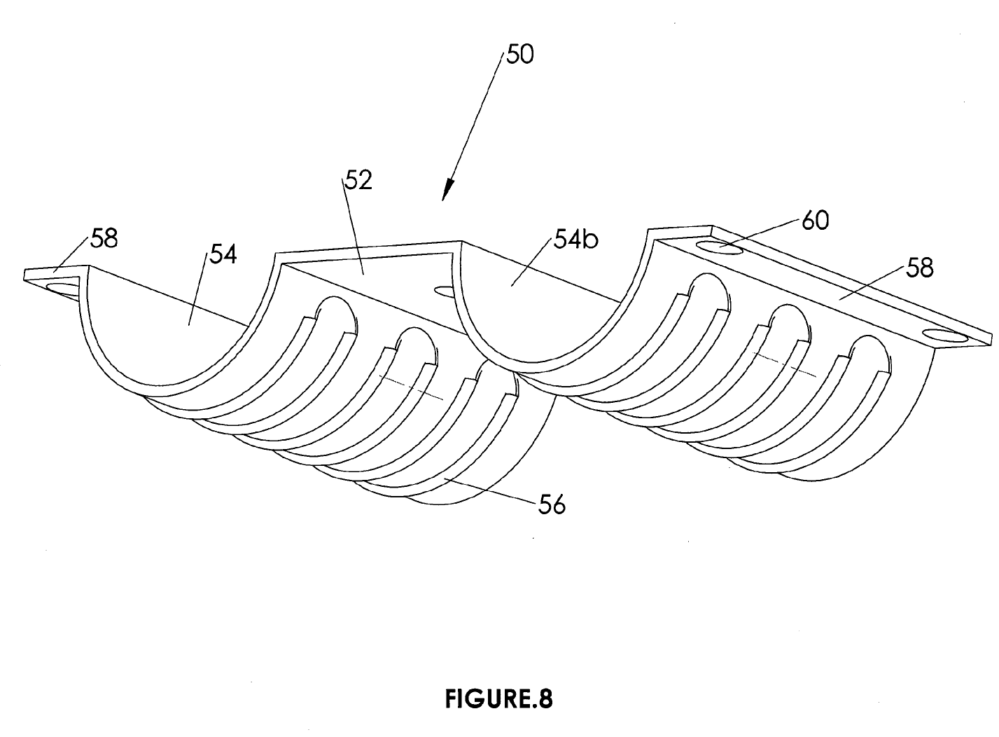

FIG. 7 is a side perspective view of a container warmer constructed and operative in accordance with another embodiment of the present invention. Container warmer 40 is substantially the same as container warmer 10 of FIGS. 1 to 3, and includes a warmer body 42, and a container holder, here illustrated as a depression 44. According to this embodiment, depression 44 includes a heating portion 45a, having a heat-conductive plate 46, and an insulating portion 45b, having an insulting plate 48. Heating portion 45a is configured and shaped for holding the outer walls of the portion of the container which is to be heated, and insulating portion 45b is configured and shaped for holding portions of the container which are to remain, substantially, unheated. Insulting plate 48 may be mounted on the entire insulating portion 45b or on any part thereof.

FIG. 8 is a bottom perspective view of a heat-conductive plate 50 for a two cradle container warmer, constructed and operative in accordance with one embodiment of the present invention. According to this embodiment, heat-conductive plate 50 includes a conductive sheet 52 shaped to define a first cradle 54 and a second cradle 54b. Heat-conductive plate 50 can be formed of a conductive metal, such as aluminum or copper. A heating element 56, here illustrated as heating filaments, is affixed to one side of heat-conductive plate 50, beneath first and second cradles 54 and 54b. Heating element 56 is preferably adapted to the shape of the bottom portion of first and second cradles 54 and 54b and configured for direct physical contact with the bottom portion of cradles 54 and 54b. Heating element 56 preferably is disposed symmetrically on the bottom portion of first and second cradles 54 and 54b, creating an even temperature. Cradle arrangement 50 further includes two mounting flanges 58 having screw apertures 60 disposed therein. Heat-conductive plate 50 can be mounted on a container warmer body, as with screws inserted through screw apertures 60.

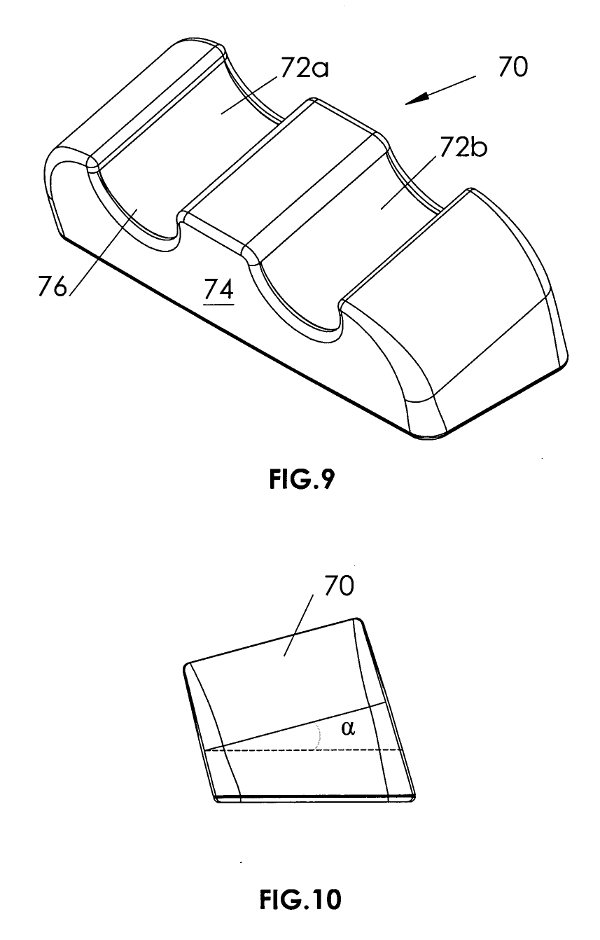

While typically it will be preferred that the container be heated in a horizontal position, as stated above, an acute angle up to about 45° may also provide a sufficient tilt between the portion of the container to be heated and the portion of the container extending from the warmer so that there is little or no heating of the upper portion by convection. One example of such a warmer is illustrated in FIGS. 9 and 10, perspective and end views, respectively, of a container warmer 70 constructed and operative in accordance with another embodiment of the present invention. Container warmer 70 includes two container holders 72a and 72b, each having walls 76 for holding a container at an acute angle α to the horizontal. Container warmer 70 includes a warmer body 74 having heating elements (not shown) associated with each container holder, as described above. The heating elements heat at least a portion of the container holders which, in turn, heat the portions of the containers held therein.

According to another embodiment of the present invention, the container warmer may include a container holder formed by one or more rotating rollers mounted inside an arcuate or semi-cylindrical cradle defined in the body of the warmer. Rotation of the rollers causes a container, disposed therein, to rotate about its longitudinal axis. Rotation of the container permits physical contact of the entire circumference of the outer walls of the container with the heat-conductive plate, thus accelerating the heating of the component contained therein.

According to yet another embodiment, the container warmer may include a body and a container holder formed by at least two synchronal rotating rollers mounted in the body, extending in parallel to a substantially horizontal axis through the body and in parallel to each other, and spaced apart. The two rotating rollers may cause a container, disposed in the container holder, to rotate about its longitudinal axis. According to this embodiment, each roller may include a heating element arranged to engage and heat the outer walls of the multi-compartment container, or of any portion thereof.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A warming apparatus for warming a container having outer walls, the apparatus comprising:
a warmer body;
at least one container holder, open at both ends, defined in said body, said container holder including holder walls adapted and configured to cradle a portion of the outer walls of a container for releasably holding said portion of the outer walls; and
at least one heating element disposed in said warmer body adjacent said container holder.

2. The warming apparatus according to claim 1, wherein each said heating element is arranged to heat at least a portion of one of said container holders.

3. The warming apparatus according to claim 1, wherein said container holder is selected from the group including a cradle, a depression and a pair of rollers.

4. The warming apparatus according to claim 1, wherein said heating element in said body heats a heat convection medium, wherein the medium is contained in said body and contacts said container holder for heating at least a portion of the holder.

5. The warming apparatus according to claim 1, wherein said container holder has a shape complementary to a portion of said container for releasably engaging said portion of said container.

6. The warming apparatus according to claim 1, further comprising a heat-conductive plate lining said container holder.

7. The warming apparatus according to claim 6, wherein said heating element is affixed to said heat-conductive plate.

8. The warming apparatus according to claim 1, wherein said warmer body further includes a temperature selector associated with each container holder.

9. The warming apparatus according to claim 1, wherein said warmer body further includes a thermostat associated with each container holder.

10. The warming apparatus according to claim 1, wherein said heating element is coupled to a portable power source.

11. The warming apparatus according to claim 1, wherein said heating element is coupled to a car outlet plug.

12. The warming apparatus according to claim 1, comprising:
two container holders defined in said warmer body, each for holding a container, each said container holder being sized to hold the outer walls of a portion of a container; and
a pair of heating elements disposed in said body, each heating element arranged to heat at least a portion of one of said container holders.

13. A warming apparatus for warming a multi-compartment container, the apparatus comprising:
a warmer body;
at least one container holder defined in said body, each for holding a multi-compartment container in a substantially horizontal position, each said container holder being sized to hold a portion of the container; and
at least one heating element disposed in said body, one of said heating elements being disposed adjacent one of said container holders for heating at least a portion of said container holder.

14. A method for forming a warming apparatus for warming a container having outer walls, the method comprising:
forming warmer body;
defining at least one container holder, open at both ends, in said body for releasably holding a container;
forming holder walls in said container holder sized and configured to cradle a portion of the outer walls of a container; and
disposing at least one heating element in said warmer body adjacent said container holder.

15. The method according to claim 14, comprising defining two container holders in said body, each for holding a portion of the outer walls of a container;
said step of defining including sizing each said container holder to cradle a portion of the outer walls of a container; and
said step of disposing including disposing two heating elements in said warmer body, each heating element being arranged for heating at least a portion of one of said container holders.

16. The method according to claim 14, wherein said at least one container holder is defined in said body for holding said container in a position where a portion of said container is warmed by said heating element and another portion of said container substantially is not warmed by said heating element.

17. The method according to claim 15, wherein said at least one container holder is defined in said body for holding said container in a position where a portion of said container is warmed by said heating element and another portion of said container substantially is not warmed by said heating element.
